(19) United States
(12) Patent Application Publication
(10) Pub. No.: US 2025/0343620 A1
(43) Pub. Date: Nov. 6, 2025

(54) Methods for monitoring and managing communicating objects, trusted device, server, and communicating objects

(71) Applicant: ORANGE, ISSY LES MOULINEAUX (FR)

(72) Inventors: Mohamed Boucadair, Chatillon (FR); Christian Jacquenet, Chatillon (FR)

(21) Appl. No.: 18/873,889

(22) PCT Filed: Jun. 15, 2023
(86) PCT No.: PCT/EP2023/066052

§ 371 Date: Dec. 11, 2024

(30) Foreign Application Priority Data
Jun. 16, 2022 (FR) FR2205889

(51) Int. Cl. H04K 3/00

(52) U.S. Cl. CPC H04K 3/45; H04K 3/825

(57) ABSTRACT

A method for monitoring communicating objects, carried out by a trusted equipment associated with a user. The monitoring method includes: detecting use of at least one persistent identifier by at least one communicating object; and triggering at least one action of jamming said use of said at least one persistent identifier by said at least one communicating object.

### PRIOR ART

The invention belongs to the general field of telecommunications.

It relates more particularly to the management of communicating objects able to ex-change data with another entity via a communication interface. There is no limitation attached to the nature of such a communication interface (radio interface such as a Bluetooth or Wi-Fi interface or a mobile network interface, a network interface such as an IP (Internet Protocol) interface, etc.) nor to the nature of the communicating objects under consideration (for example connected watch, sensor, motion detector, terminal such as a mobile phone or smartphone, wireless headphones, etc.).

The invention thus applies for example, preferably but without limitation, to connected objects used in an Internet of Things (IoT) context.

As mentioned in document RFC 8386 published by the IETF by R. Winter et al, entitled “Privacy Considerations for Protocols Relying on IP Broadcast or Multicast”, May 2018, some communication protocols are known to use identifiers persistently over time and to transmit these identifiers to other entities, for example in messages broadcast using broadcast or multicast techniques. Such identifiers, referred to as “persistent”, may be of various natures: MAC (Medium Access Control) address of the communicating object implementing the protocol in question, universally unique identifier (UUID), IP prefix or address, etc. They are known to uniquely identify the communicating device to which they are attached, such that prolonged (in order words persistent) use thereof offers third parties the possibility of obtaining information about, including tracking, the behavior and/or habits of the user of the communicating device in question.

One example of such tracking, based on signals transmitted by wireless headphones having a Bluetooth interface or by a smartphone equipped with a Wi-Fi interface, is described in the article by R. Lea published in Newsweek and entitled “How your Bluetooth headphones could be used to track you: ‘Extremely concerning’”, Sep. 6, 2021. Listening to and analyzing these signals, which persistently carry a MAC address, makes it possible to obtain information about the movements of users of the devices transmitting these signals.

Such techniques may easily be generalized so as to create collaborative tools that allow the large-scale collection of information that, once correlated, may jeopardize users' privacy.

Moreover, services characteristic of the Internet of Things (telemedicine services, home monitoring, etc.) may be vulnerable in that connected objects supporting these services are exposed to hacking risks based on their MAC addresses being tracked. In this regard, mention may be made of certain denial of service (DOS) attacks carried out recently that exploited this vulnerability by using connected objects as relays for the attack traffic, this having had the effect of considerably amplifying the volume of the attack traffic. Such an attack was carried out in particular in 2016 against one of the largest content hosts in Europe from a botnet consisting of nearly 150 000 unprotected IP surveillance cameras that were able to launch a denial of service attack of more than 1.5 Tbit/s. This resulted in lengthy unavailability of some of the content servers of the host in question.

In order to minimize such risks, some operating systems (OS) activate a procedure of randomizing MAC addresses, that is to say these operating systems or the objects that embed them (for example mobile terminals) use randomly generated MAC addresses to communicate with other objects connected to the same local area network. However, this procedure is not supported by most technologies implemented by communicating objects, and in particular by IoT objects such as motion detectors or temperature sensors.

Finally, it should be noted that users are not necessarily informed of the ability of various communicating objects to disclose persistent identifiers, for example when they are invoked by a controller to execute a data collection command or when they are exploited to relay attack traffic.

It should be noted that, although they have been described with reference to persistent identifiers such as MAC addresses, the abovementioned drawbacks are still valid for other types of persistent identifier, such as IP addresses or prefixes, UUID, etc.

### SUMMARY OF THE INVENTION

The invention proposes a mechanism that makes it possible in particular to rectify these drawbacks, and that may advantageously be applied to any type of persistent identifier (MAC address, IP address or prefix, UUID, etc.).

More specifically, the invention relates to a method for monitoring communicating objects, carried out by a trusted equipment associated with a user, this monitoring method comprising:
a step of detecting use of at least one persistent identifier by at least one communicating object; and
a step of triggering at least one action of jamming said use of said at least one persistent identifier by said at least one communicating object.

In correlation, the invention also targets a trusted equipment associated with a user, configured to monitor communicating objects, this trusted equipment comprising:
a detection module, configured to detect use of at least one persistent identifier by at least one communicating object; and
a trigger module, configured to trigger at least one action of jamming said use of said at least one persistent identifier by said at least one connected object.

No assumption is made as to the nature of the equipments involved in the invention, be these communicating objects (which may be for example, as mentioned above, sensors, terminals, connected watches, wireless headphones, webcam cameras, etc.) or the trusted equipment (which may be in particular a terminal such as a smartphone, a set top box, a CPE (customer premises equipment), etc.), or as to the nature of the communication interfaces used by the communicating objects (for example a radio communication interface such as a Bluetooth or Wi-Fi interface, an IP network interface, etc.).

Furthermore, a trusted equipment may be associated with one or more users.

The invention thus proposes a mechanism based on the detection of the use of persistent identifiers by communicating objects located “close” to a trusted equipment for the user (that is to say visible to said user) and on the control of this use via a jamming action triggered by the trusted equipment. The trusted equipment is advantageously associated with the user; in other words, it is a trusted equipment for said user, mandated thereby, or with their agreement, to monitor a given area (for example, it may have been designated or chosen by said user to monitor a particular area). This trust may be granted by the user to the equipment in question, for example because it belongs to said user, or said user manages it or takes responsibility for its use. For example, a CPE is often owned by the connectivity service provider; in this case, the client (user within the meaning of the invention) may then signify their agreement to the connectivity service provider, for example when they subscribe to the connectivity service, so that the CPE plays the role of a trusted equipment within the meaning of the invention. A user may also use the management interface of the CPE or a dedicated portal of the operator to indicate their consent. It may also be reinforced by hardware means, computer means, software means or computer security means, etc.

The area monitored by the trusted equipment associated with the user is not necessarily geographical; it may be linked to a network, to an IP address or prefix, etc. Furthermore, various configurations may be envisaged: one and the same area may be monitored by one or more trusted equipments associated with one and the same user, or distinct trusted equipments may be configured to monitor distinct areas, for example depending on the nature of the services associated with the use of the monitored communicating objects (for example an “IoT” area for networked objects, a “professional” area for communicating objects used for strictly professional purposes (for example a company network), a “personal” area for communicating objects used for strictly personal purposes, etc.).

It should be noted that the communicating objects monitored by the trusted equipment do not necessarily belong to the user. However, it may be the case that the context in which these objects operate, and/or the correlation of the persistent identifiers that they use, reveal identification information in relation to the user. The user may thus choose and/or configure a trusted equipment so that it monitors all communicating objects that it is able to detect within the perimeter of an area in which the user is located or wishes to visit (or more generally, the areas where the user is likely to be present). The trusted equipment may also be fixed or mobile.

Moreover, no assumption is made as to how the trusted equipment is able to detect such communicating objects. This detection may thus be carried out using multiple methods: it may for example be based on the existence of a network connection (via a wired or wireless network or both) with the objects in question, on a mechanism for scanning the signals transmitted via one or more radio interfaces (for example Bluetooth, Wi-Fi), on information received from a third-party entity or from the communicating objects themselves, on listening to signals broadcast by the communicating objects (for example broadcast in broadcast or multicast mode), etc., or even a combination of all or some of these methods. In any event, these communicating objects are located in a detection area managed by the trusted equipment and in which their presence is visible thereto.

By jamming the use of a persistent identifier by a communicating object detected by the trusted equipment associated with a user, the invention advantageously renders obsolete the identification information relating to the user that this use is liable to disclose. Specifically, these jamming actions add noise to the use of the persistent identifier, which is able to be controlled by the trusted equipment (in particular with regard to its level, its location, etc.), so that a malicious third party is no longer able to exploit a persistent identifier so as to deduce unambiguous identification information in relation to a user therefrom. Owing to the plurality and the diversity of the jamming actions able to be executed, the invention also makes it possible to adapt to the constraints of communicating objects, for example according to whether or not they are capable of executing such actions, according to the context in which they and/or the user are located, and/or according to the level of security of the characteristic data of the user. Other factors may of course be taken into account to select the one or more jamming actions to be triggered.

Thus, in one particular embodiment, the monitoring method furthermore comprises, for at least one said communicating object identified in the detection step and at least one persistent identifier used by this communicating object, a step of determining whether said communicating object is able to execute a said action of jamming the use of this persistent identifier, the triggering step comprising, where applicable, sending a command to this communicating object so that it executes said jamming action.

The trusted equipment may also verify whether the communicating object is under the control of the user, typically whether it belongs to said user or whether the user manages it. Specifically, the fact that the user controls the communicating object facilitates the controlling of the communicating object so as to trigger the execution of a jamming action locally where applicable (if the object is capable of this).

Such a jamming action comprises for example the communicating object in question using another identifier of the same nature as said persistent identifier in place thereof, this other identifier being able to be chosen by the communicating object or by the trusted equipment or else by a trusted third-party entity. Thus, by way of illustration, when the persistent identifier under consideration is a MAC address, the jamming action may consist in activating an action of randomizing MAC addresses by way of the communicating object, provided that said communicating object is able to implement such a technique.

When such a jamming action consisting in replacing the persistent identifier with another identifier of the same nature is executed by the communicating object and triggered by the trusted equipment, the monitoring method may furthermore comprise a step of updating at least one routing and/or traffic filtering rule relating to the communicating object with said other identifier.

This updating makes it possible to avoid the service provided or observed by the communicating object being impacted or degraded by the change of identifier. In other words, the updating aims to ensure that the services rendered by or accessible to the communicating object are not penalized when it uses the other identifier as a replacement for the persistent identifier, and that this replacement is transparent for the service provided or observed by the communicating object.

In one embodiment, for at least one said communicating object identified in the detection step and at least one persistent identifier used by this communicating object, the triggering step comprises sending, to at least one remote server, an instruction to trigger use of this persistent identifier by at least one other communicating object selected by said at least one remote server.

The trusted equipment and the remote server themselves preferably maintain a trust relationship; this trust relationship may be established for example via a prior mutual authentication mechanism implemented when establishing a connection between the trusted equipment and the remote server. It should be noted that one or more connections may be established between a trusted equipment and said server, in particular when said trusted equipment is associated with multiple users.

This embodiment may be used in addition to or as a replacement for the previous embodiment, depending on the context. For example, it may be implemented when the communicating object does not belong to the user or more generally is not under the control of the user (and therefore cannot be easily controlled by the trusted equipment), and/or when the communicating object is not capable of executing a jamming action. In this case, by virtue of this embodiment, the trusted equipment is able to address a remote server managing other communicating objects so that one or more jamming actions are triggered and executed by all or some of these other communicating objects.

The jamming actions triggered at these other communicating objects include for example these other communicating objects using the persistent identifier. This use may be real, that is to say that the persistent identifier is actually used by the communicating object to communicate with other entities, or fictitious and simulated, that is to say that the use is fake, the object simulates use of the persistent identifier, but it does not use it for its own needs. Such fictitious use is referred to here as “emulation of a persistent identifier”.

One example of emulation of a persistent identifier by a communicating object thus consists in assigning the persistent identifier to an interface of the communicating object (this assignment being able to be chosen by the server or by the communicating object itself) and in advertising this identifier such that it is visible to equipments located in the immediate neighborhood of the communicating object (such equipments scan for example the signals transmitted by the communicating object or analyze the messages that it sends); however, the persistent identifier is not, in the context of this emulation, used by the communicating object for its own needs, for example when it sends an activity report at the request of an external controller. Furthermore, the communicating object may also be configured to reject any attempt and/or request to establish a connection associated with the persistent identifier that has been assigned thereto. It should be noted that one and the same communicating object may be configured to emulate multiple distinct identifiers.

In this way, the identification information liable to be revealed regarding the user by the use of these one or more persistent identifiers is jammed, since these one or more persistent identifiers are used by multiple communicating objects (the one detected by the trusted equipment and the one or more mandated by the remote server). Indeed, this embodiment expands the area containing the communicating objects that are able, by using the one or more persistent identifiers detected by the trusted equipment, to participate in the jamming of the information liable to be revealed by the use of these identifiers.

In one particular embodiment, the instruction sent to the remote server may furthermore comprise other indications, such as for example an indication of a duration of use of said persistent identifier by said at least one other communicating object and/or an indication of an area to which said at least one other communicating object asked to use the persistent identifier should be attached.

Of course, these examples are given only by way of illustration, and other indications may be envisaged.

In one variant embodiment, the abovementioned indications or other indications (for example maximum number of persistent identifiers associated with a user, desired level of jamming, type of persistent identifiers in question, identities of trusted equipments associated with the user, etc.) may be available in a profile associated with the user, accessible to the remote server. This profile may have been provided to the remote server or have been identified at the remote server by the trusted equipment, for example during the mutual authentication of the trusted equipment and the remote server, or else may be made accessible to the remote server in a database, etc. In the case mentioned above in which a trusted equipment is associated with multiple users and only one connection is established between the trusted equipment and the server, it is possible to envisage filling in the identifier of one of said users when invoking the server to trigger a jamming action so that the server is able to associate this invocation with the profile of the user in question.

Thus, as is apparent in the light of what has just been described, the invention relies on one or more trusted equipments associated with the user but also on the communicating objects monitored by these trusted equipments and able to execute jamming actions, on one or more remote servers that may be mandated by the one or more trusted equipments to implement actions of jamming the use of persistent identifiers as detected, where applicable, by said one or more trusted equipments, and also on the communicating objects controlled by these one or more remote servers so as to execute these jamming actions.

According to another aspect, the invention therefore also targets a method for managing communicating objects, carried out by a server, this management method comprising:
a step of receiving, from a trusted equipment associated with a user, an instruction to trigger use of at least one given persistent identifier by at least one communicating object managed by said server;
a step of selecting, for said at least one persistent identifier designated in said instruction and for said user, at least one communicating object from among a plurality of communicating objects managed by the server, able to use said at least one persistent identifier; and
a step of sending a command to said at least one selected communicating object so that it uses said at least one persistent identifier.

In correlation, the invention also relates to a server configured to manage communicating objects, this server comprising:
a reception module, configured to receive, from at least one trusted equipment associated with a user, at least one instruction to trigger use of at least one given persistent identifier by at least one communicating object managed by said server;
a selection module, configured to select, for said at least one persistent identifier designated in said at least one instruction and for said user, at least one communicating object from among a plurality of communicating objects managed by the server, able to use said at least one persistent identifier; and
a control module, configured to send a command to said at least one selected communicating object so that it uses said at least one persistent identifier.

The management method and the server according to the invention contribute to the same advantages mentioned above as the monitoring method and the trusted equipment according to the invention.

In one particular embodiment, the management method furthermore comprises, before executing the selection step and the configuration step, a step of authenticating the trusted equipment associated with the user.

As mentioned above, this step makes it possible to ensure a trust relationship between the trusted equipment and the remote server. It may also be accompanied by a step consisting in verifying that the trusted equipment is actually authorized to send such an instruction to the remote server for said user.

In one particular embodiment, said at least one communicating object to which the command to use said at least one persistent identifier is sent is selected by the server from among a plurality of communicating objects managed by said server and attached to an area defined for or by the user.

In one embodiment, at least one said communicating object to which the command to use said at least one persistent identifier is sent is selected randomly by the server or according to at least one constraint defined for or by the user.

In one particular embodiment, the management method furthermore comprises, for at least one said communicating object selected for the user, a step of cancelling or a step of renewing said command to use said at least one persistent identifier for which said communicating object has been selected.

These embodiments offer great flexibility in terms of the selection of the communicating objects using the one or more persistent identifiers and/or their configuration, and make it possible to adapt this selection and/or this configuration to the context, as well as to the needs of the user and/or their preferences.

According to yet another aspect, the invention also targets a method for the use of an identifier by a communicating object, said method comprising:
a step of receiving, from a server, a command to use a persistent identifier already being used by another communicating object, said command providing said communicating object with an indication of at least one behavior to be adopted by said communicating object in the event of an attempt and/or request, made by a third-party device, to establish a connection with the communicating object by way of said persistent identifier;
a step of using said persistent identifier and implementing said at least one behavior.

In correlation, the invention also relates to a communicating object comprising:
a reception module configured to receive, from a server, a command to use a persistent identifier already being used by another communicating object, said command providing said communicating object with an indication of at least one behavior to be adopted by said communicating object in the event of an attempt and/or request, made by a third-party device, to establish a connection with the communicating object by way of said persistent identifier;
an execution module configured to use said persistent identifier and implement said at least one behavior.

A behavior to be adopted by the communicating object in the event of an attempt and/or request to establish a connection is typically the rejection of the attempt and/or request to establish a connection, the tracking of attempts and/or requests to establish a connection, the establishment of the connection, etc. This indication provided by the server makes it possible to define a mode of use of the persistent identifier by the communicating object, namely whether it should emulate the persistent identifier (in other words use it fictitiously, and advertise it without establishing a connection associated with this persistent identifier or using it for its own needs), or, on the contrary, actually use it. This mode of use may differ depending on context, or on the communicating objects mandated by the server to use the persistent identifier. Indeed, if a malicious third party manages to detect that multiple communicating objects are configured to emulate a persistent identifier and to systematically reject any attempt and/or request to establish a connection on the basis of this persistent identifier, this may raise suspicions with this third party and reduce the effectiveness of the jamming implemented by the invention.

The advantages associated with the communicating object and with the use method according to the invention are the same as those cited above for the trusted equipment and for the server, and also for the monitoring and management methods respectively implemented thereby.

According to yet another aspect, the invention targets a method for executing a jamming action, carried out by a communicating object, this method comprising:
a step of using a persistent identifier;
a step of receiving a command from a trusted equipment associated with a user so that the communicating object executes an action of jamming the use of said persistent identifier; and
a step of executing said jamming action.

In correlation, the invention also targets a communicating object comprising:
a communication module, configured to use a persistent identifier;
a reception module, configured to receive a command from a trusted equipment associated with a user (U) so that the communicating object executes an action of jamming the use of said persistent identifier by said communication module; and
an execution module configured to execute said jamming action.

As mentioned above, such a jamming action controlled by the trusted equipment is for example the generation and use, by the communicating object, of another identifier of the same nature as the persistent identifier in place of the latter. It preferably applies to all ongoing connections of the communicating object that were using the persistent identifier.

The advantages associated with the communicating object and with the execution method according to the invention are the same as those mentioned above for the trusted equipment, for the server, and for the communicating object according to the invention, and also for the monitoring, management and use methods according to the invention respectively implemented thereby.

In one particular embodiment, the monitoring, management, use and execution methods are implemented by a computer.

The invention also targets a computer program on a recording medium, this program being capable of being implemented in a computer or more generally in a trusted equipment according to the invention and comprising instructions designed to implement a monitoring method as described above.

The invention also targets a computer program on a recording medium, this program being capable of being implemented in a computer or more generally in a server according to the invention and comprising instructions designed to implement a management method as described above.

The invention also targets a computer program on a recording medium, this program being capable of being implemented in a computer or more generally in a communicating object according to the invention and comprising instructions designed to implement a use method as described above.

The invention also targets a computer program on a recording medium, this program being capable of being implemented in a computer or more generally in a communicating object according to the invention and comprising instructions designed to implement an execution method as described above.

Each of these programs may use any programming language, and be in the form of source code, object code, or of intermediate code between source code and object code, such as in a partially compiled form, or in any other desirable form.

The invention also targets a computer-readable information medium or recording medium including instructions of a computer program as mentioned above.

The information medium or recording medium may be any entity or device capable of storing the programs. For example, the medium may include a storage means, such as a ROM, for example a CD-ROM or a microelectronic circuit ROM, or else a magnetic recording means, for example a hard disk, or a flash memory.

Moreover, the information medium or recording medium may be a transmissible medium such as an electrical or optical signal, which may be routed via an electrical or optical cable, by radio link, by wireless optical link or by other means.

The program according to the invention may in particular be downloaded over the Internet.

As an alternative, the information medium or recording medium may be an integrated circuit in which a program is incorporated, the circuit being designed to execute or to be used in the execution of the monitoring, management, use and execution methods according to the invention.

According to another aspect, the invention also targets a jamming system comprising:
at least one trusted equipment associated with a user according to the invention, configured to monitor communicating objects;
at least one server according to the invention; and
a plurality of communicating objects comprising at least one communicating object according to the invention (typically a communicating object configured to implement the execution method and/or a communicating object configured to implement the use method).

The advantages associated with this jamming system are the same as those cited above for the trusted equipment and for the server, and also for the monitoring and management methods respectively implemented thereby.

Furthermore, as mentioned above, the invention applies to various types of persistent identifier. For example, at least one said persistent identifier is:
a MAC, Medium Access Layer, address;
an IP, Internet Protocol, address;
an IP prefix;
a Service Set Identifier, SSID;
an identifier of the trusted equipment; or
an identifier assigned to a radio interface.

It is also possible to envisage, in other embodiments, the monitoring, use, execution and management methods, the trusted equipment, the server, the communicating objects and the jamming system according to the invention having all or some of the abovementioned features in combination.

### BRIEF DESCRIPTION OF THE DRAWINGS

Other features and advantages of the present invention will emerge from the description given below, with reference to the appended drawings, which illustrate one exemplary embodiment thereof that is in no way limiting. In the figures:

FIG. 1 shows, in its environment, a jamming system according to the invention, in one particular embodiment;

FIG. 2 schematically shows the hardware architecture of a computer that is able to be or host a trusted equipment or a server or else a communicating object of the jamming system of FIG. 1;

FIG. 3 shows the main steps of a monitoring method according to the invention as they are implemented, in one particular embodiment, by a trusted equipment of the jamming system of FIG. 1;

FIG. 4 shows the main steps of an execution method according to the invention as they are implemented, in one particular embodiment, by a communicating object of the jamming system of FIG. 1;

FIG. 5 shows the main steps of a management method according to the invention as they are implemented, in one particular embodiment, by a server of the jamming system of FIG. 1;

FIG. 6 illustrates one example of maps of communicating objects emulating a persistent identifier that changes over time (FIG. 6A and then FIG. 6B); and

FIG. 7 shows the main steps of a use method according to the invention as they are implemented, in one particular embodiment, by a communicating object of the jamming system of FIG. 1.

### DESCRIPTION OF THE INVENTION

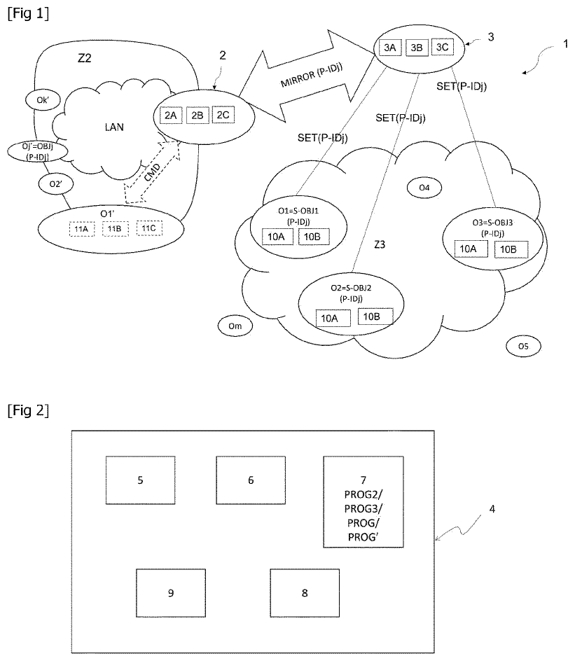

FIG. 1 shows a jamming system (or blurring system) 1 according to the invention, in one particular embodiment. The jamming system 1 is configured to offer users what is referred to as a jamming service S, also designated here as MANTEC for “MANanaging privacy inferred by nearby connecTEd ObjeCts”. This MANTEC service S consists in detecting the use of persistent identifiers by communicating objects, these persistent identifiers being liable to disclose identification information relating to said users (for example information about their identities, their habits, their behaviors, their locations, etc.), and in triggering actions of jamming such use in order to render obsolete said identification information that could thus be obtained. The jamming system 1 thus makes it impossible to exploit the information that could be derived from the use of persistent identifiers, in particular for fraudulent purposes.

No assumption is made as to the nature of the communicating objects liable to use such persistent identifiers, or as to the persistent identifiers in question.

Thus, for example, the communicating objects may be sensors, terminals such as smartphones or digital tablets, connected watches, wireless headphones, webcam cameras, etc., having one or more communication interfaces via which they are able to exchange data with other entities. Such a communication interface may be a radio interface (for example Bluetooth, Wi-Fi, cellular mobile network, etc.), an IP network interface (wired or wireless or both), etc.

Moreover, a persistent identifier designates any type of information uniquely or unambiguously identifying the communicating device with which it is associated, such that prolonged (that is to say persistent, hence its name) use thereof offers third parties the possibility of obtaining information about (including tracking) the identity, behavior and/or habits of the user of the communicating device in question. Said persistent identifier may be for example a MAC address, an IP address or an IP prefix, a UUID or SSID, a name associated with the communicating device broadcast or assigned to a communication interface (for example, “Bob's headphones”), etc. The duration of use beyond which it is considered by the jamming system 1 that an identifier is persistent may vary according to the context and nature of the identifier. For example, it is possible to consider a maximum duration of use of 24 hours for an IP address, or 60 minutes for a MAC address.

In the embodiment described here, in order to offer the service S, the jamming system 1 comprises the following elements:
at least one trusted equipment 2, according to the invention, and associated with at least one user U who has subscribed to the service S with an operator OP, a user U possibly comprising one or more people (for example, a group of employees of a company). For example, the trusted equipment 2 was chosen by the user U and declared as such thereby with the operator OP when subscribing to the service S or subsequently. This trust granted to the equipment 2 by the user U may be motivated by various reasons; for example, the user U owns the trusted equipment 2, or manages it, or else takes responsibility for the use thereof. It may be reinforced by computer or software means, or by any other means (for example hardware means or contextual means). Such a trusted equipment 2 may in particular be the smartphone of the user U or their connected watch, a CPE equipment or a set top box, a connected television, a webcam camera, or an object dedicated to the invention, etc. It should be noted that the trusted equipment 2 may be either fixed or mobile;
at least one server 3 according to the invention (also designated as “MANTEC server 3” in the remainder of the description), able to communicate with the trusted equipment 2 and to assist it, upon request thereof, in implementing jamming actions; and
a plurality of communicating objects comprising in particular communicating objects O1, . . . , Om, m designating an integer greater than or equal to 1, managed by said at least one MANTEC server 3 and that the MANTEC server 3 is able to address in order to execute jamming actions when it assists the trusted equipment 2. The communicating objects 01, . . . , Om are therefore able and configured, upon request of the MANTEC server 3, to execute actions of jamming the use of one or more given identifiers, indicated by the MANTEC server 3 (one and the same communicating object is able to execute actions of jamming multiple distinct identifiers, and multiple communicating objects are able to execute actions of jamming one and the same identifier). In the embodiment described here, the communicating objects O1, . . . , Om are in accordance with the invention and the jamming action that they are able to execute is the use of one or more identifiers designated by the MANTEC server 3 according to a mode of use defined by the MANTEC server 3. Various ways of using these one or more identifiers may be envisaged. Thus, for example, one jamming action executed by a communicating object O1, . . . , Om may consist in emulating an identifier, that is to say in “simulating” use thereof: the identifier in question is assigned to a communication interface of the communicating object (the interface in question may be chosen by the communicating object or by the MANTEC server 3) and advertised thereby so as to make it visible to equipments located in its immediate neighborhood and that are listening for signals and/or messages transmitted via this interface. However, in the context of this emulation, this identifier is not used by the communicating object for the needs of the services for which the communicating object is natively used and for which the communicating object is intended (for example to collect data that may be transmitted regularly to an external controller). As a variant, it may be envisaged that the MANTEC server 3 asks a communicating object to actually use a given identifier, that is to say to assign it to one of its interfaces (the interface in question may be chosen by the communicating object or by the MANTEC server 3), to advertise it, and to establish connections with other entities on the basis of this identifier. Such communicating objects may or may not be intended exclusively to implement the invention (that is to say be communicating objects dedicated to jamming persistent identifiers). They may be pre-existing communicating objects intended for other purposes and otherwise exploited for the needs of the invention (for example, CPEs, hotspots, routers or IoT objects).

Each trusted equipment 2 associated with the user U is configured to monitor communicating objects O1′, O2′, . . . , Ok′, k designating an integer greater than or equal to 1, located in its “neighborhood”. All or some of these communicating objects may be in accordance with the invention and have modules configured to implement an execution method according to the invention in order to participate in the implementation of the service S. Where applicable, the communicating objects configured in this way from among the communicating objects O1′, O2′, . . . , Ok′ belong to the jamming system 1.

In the example envisaged here, the communicating objects O1′, O2′, . . . , Ok′ are located in the immediate neighborhood of the trusted equipment 2, which neighborhood may be a radio neighborhood, that is to say the trusted equipment 2 is able to receive radio signals transmitted, where applicable, by such communicating objects (for example Bluetooth signals, Wi-Fi signals, etc.), and/or a network neighborhood, that is to say the trusted equipment 2 is able to receive messages transmitted, where applicable, by such objects, for example via a local area network (for example ARP (Address Resolution Protocol) messages broadcast in broadcast mode). For example, by way of illustration, the trusted equipment 2 may be a CPE connected to a local area network and the communicating objects O1′, O2′, . . . , Ok′ may be devices connected to the local area network.

As a variant, it is also possible to envisage that the trusted equipment 2 is configured to also monitor communicating objects located in a less immediate neighborhood comprising the immediate radio/network neighborhood of the immediate radio/network neighborhood of the trusted equipment 2 that has just been described. In other words, according to this variant, the communicating objects located in the radio and/or network neighborhood of the communicating objects detected by the trusted equipment 2 in its immediate radio and/or network neighborhood may also be monitored by the trusted equipment 2. To this end, the trusted equipment 2 may receive the signals and/or messages sent by the communicating objects located in its less immediate neighborhood via the communicating objects located in its immediate neighborhood or via other intermediate devices. Thus, according to this variant, as soon as the trusted equipment 2 is able to detect signals and/or messages sent by a communicating object and received directly from this communicating object or via an intermediate device, the communicating object in question is considered to be located in the neighborhood of the trusted equipment 2 and is able to be monitored thereby.

It should be noted that the communicating objects monitored by the trusted equipment 2 do not necessarily belong to the user U. However, it may be the case that the context in which they operate, and/or the correlation of the persistent identifiers that they use, may reveal identification information in relation to the user U.

It should also be noted that a trusted equipment 2 may be configured, by the user U, to carry out such monitoring at all times or only when it is located in what is referred to as a given monitoring area (for example an area in which the user U is located or envisages visiting). Such a monitoring area may be characterized by one or more parameters such as a network identifier (for example an SSID, for Service Set Identifier, of a wireless local area network (WLAN)), an IP address or prefix (IPv4 or IPv6) allocated to the trusted equipment 2, GPS (Global Positioning System) coordinates, or else a combination of such parameters. It may comprise multiple subareas defined for one and the same trusted equipment 2 for example by way of an OR operation “OR(value1,value2, . . . )”, where “value1, value2, . . . ” denote values of the parameters under consideration in the subareas in question, or an AND operation “AND(value1, value2, . . . )” when multiple parameters are envisaged to characterize the monitoring area, or else a logical combination of these operations. As a variant, the monitoring area may be defined by way of an exclusion operation “NOT (value1)”; in other words, the monitoring area corresponds to any area for which the value of the parameter under consideration is other than “value1”.

By way of illustration in the example envisaged here, it is assumed that a monitoring area Z2 is defined for the trusted equipment 2 for the user U: in other words, the trusted equipment 2 is configured to implement the service S when it detects that it is located in this monitoring area Z2; outside this monitoring area Z2, it does not participate in the implementation of the service S for the user U.

Each trusted equipment 2 is configured here with a list of MANTEC servers 3 that it is able to address if necessary to trigger jamming actions; each MANTEC server 3 is identified in the list by at least one item of reachability information such as an IP address, a domain name, a port number, etc.

As a variant, the list of MANTEC servers may be obtained dynamically by the trusted equipment 2, for example by interrogating another entity such as a database accessible to the trusted equipment 2. It should be noted that this list may change over time, depending on the position of the trusted equipment 2 or other parameters.

In the example envisaged in FIG. 1, for the sake of simplification, consideration is given to a single trusted equipment 2 associated with a single user U and configured with a single MANTEC server 3 capable of providing its assistance to the trusted equipment 2. However, these assumptions are not limiting per se and other configurations of the jamming system 1 may be envisaged, such as for example multiple trusted equipments 2 associated with one and the same user depending on the geographical area in which they are located or on their mobility, or multiple MANTEC servers 3 configured with a trusted equipment 2 and located in different geographical areas (this advantageously allows the trusted equipment 2 to simultaneously contact multiple MANTEC servers 3 without requiring any particular coordination of the MANTEC servers 3 with one another), or one and the same trusted equipment 2 associated with multiple users, etc.

It is assumed that there is a trust relationship between the trusted equipment 2 and each MANTEC server 3 with which it is configured, for example via the implementation of an association procedure between these equipments. Authentication information may thus be provided to the trusted equipment 2 so that it is able to authenticate itself in this association with a MANTEC server 3, such an authentication procedure being triggered by the establishment of a connection between the trusted equipment 2 and the MANTEC server 3. It is assumed that only one connection is established between the trusted equipment 2 and the MANTEC server 3 for the user U.

Such an association allows the trusted equipment 2 and the MANTEC server 3 to exchange various types of information in order to implement the service S, and in particular allows the MANTEC server 3 to be able to identify the user U for whom it is invoked. The MANTEC server 3 is then able to access a profile of this user U (stored locally or accessible from a remote entity) and put in place jamming actions in accordance with the policies defined by this profile. Such a profile may in particular define all or some of the following information:
one or more areas of intervention Z3 of the MANTEC server 3, placed under its control in the context of the service S, and in which jamming actions are able to be executed (that is to say to which all or some of the objects O1, . . . , Om managed by the MANTEC server 3 are attached). The organization of the areas of intervention and their association with MANTEC servers reflects the putting in place of a local policy of the operator that provides the service S. Such a local policy may be instantiated based on information provided by the users of the service S (for example by the user U, depending on their location at a given time or their travel plans). Such an area of intervention Z3 may be associated with a geographical area (for example a district, a city, a department, a region, a country, etc.) or, as a variant, with a particular network (for example local area network of the user, operator network, etc.), or with a service (for example telemedicine, etc.). It may be defined by way of the OR, AND and NOT operations mentioned above. If no area of intervention Z3 is defined in the profile of the user U, it is possible to envisage using a default area of intervention, corresponding for example to a home local area network of the user;
the desired level of jamming (for example level of duplication of the use of persistent identifiers);
the one or more types of persistent identifier in question;
the maximum number of identifiers, associated with the user, to be jammed;
the identity of the trusted equipments 2 associated with this user;
etc.

All or some of the information contained in the profile of the user U may be provided by the user U themselves when subscribing to the service S, for example, or at any other time, and/or be provided by the operator OP of the service S according to the type of subscription of the user U (which may be defined for example according to the nature and the maximum number of areas of intervention), context, the mobility of the user U, the nature and capabilities of connected objects managed by the MANTEC servers 3, etc.

The association, and more specifically the connection, between the trusted equipment 2 and a MANTEC server 3 may be permanent, that is to say present throughout the duration for which the service S is implemented for the user U, or one-off, that is to say be established only if the trusted equipment 2 needs the assistance of the MANTEC server 3 to implement the service S for the user U. It should be noted that, when the trusted equipment 2 is associated with multiple users, it is possible to envisage establishing one or more associations/connections (for example, one connection per user) between the trusted equipment 2 and the MANTEC server 3. If a single connection is used, the identifier of a user should then be filled in by the trusted equipment 2 during its exchanges with the MANTEC server 3 so that the latter is able to associate a jamming request with the profile of the user in question.

In the embodiment described here, each trusted equipment 2, each MANTEC server 3 and each communicating object of the jamming system 1 (in particular the communicating objects O1, . . . , Om and the communicating objects from among the objects O1′, . . . , Ok′ that are configured to implement an execution method according to the invention) has the hardware architecture of a computer 4 as shown schematically in FIG. 2, or is hosted by such a computer.

The computer 4 comprises in particular a processor 5, a random access memory 6, a read-only memory 7, a non-volatile memory 8, and communication means 9 enabling in particular the entities of the jamming system 1 to communicate with one another.

The read-only memory 7 of the computer 4 constitutes a recording medium in accordance with the invention, able to be read by the processor 5 and on which there is recorded a computer program in accordance with the invention.

More specifically, the read-only memory 7 of the computer 4 comprises, when the latter is or hosts a trusted equipment 2 in accordance with the invention, a recording of a computer program PROG2, comprising instructions defining the main steps of a monitoring method according to the invention.

This program PROG2 defines functional modules of the trusted equipment 2 that rely on or control the hardware elements 5 to 9 of the computer 4 that are cited above. These modules comprise, in particular, in the embodiment described here:
a first detection module 2A, configured to detect whether the trusted equipment 2 is located in its monitoring area Z2, and activate, where applicable, the other modules of the trusted equipment 2 participating in the implementation of the service S for the user U. To this end, the first detection module 2A uses the one or more parameters characterizing the monitoring area Z2 (for example network identifier, IP address or prefix, GPS coordinates or combination of these parameters) with which the trusted equipment 2 has been previously configured by the user U. In the embodiment described here, the first detection module 2A is configured to monitor continuously (that is to say without interruption) whether or not the trusted equipment 2 is located in its monitoring area Z2. As a variant, it may be configured statically or dynamically by the user U to carry out this monitoring over a given period of time, via a user interface provided for this purpose;
a second detection module 2B, configured to detect use of at least one persistent identifier by at least one communicating object O1′, . . . , Ok′ monitored by the trusted equipment 2. To this end, the second detection module 2B is configured here to scan, continuously or at a determined frequency (for example at a regular frequency), the signals and/or the messages transmitted by the communicating objects O1′, . . . , Ok′ located in its radio and/or network neighborhood, as mentioned above, and to analyze these signals and/or messages. As indicated above, in one variant in which the trusted equipment 2 is configured to also monitor communicating objects located in its less immediate neighborhood (typically not directly visible to the equipment 2), it may receive these signals and/or messages from intermediate devices (typically communicating objects from among the communicating objects located in its immediate neighborhood); and
a trigger module 2C, configured to trigger at least one action of jamming such use detected by the second detection module 2B. In the embodiment described here, the trigger module 2C comprises three submodules:
   a first submodule 2C1, configured to determine which one or more types of jamming actions to trigger following the detection of the second detection module 2B, and in particular whether such a jamming action is triggered at the communicating object at the origin of the detected use and/or at a remote MANTEC server 3. The first submodule 2C1 may, to this end, take into account the capabilities of the communicating object at the origin of the detected use, whether or not it belongs to the user U, the persistent identifier detected, the desired level of jamming, etc., as described further below;
   a second submodule 2C2 and a third submodule 2C3, which are activated selectively or cumulatively by the first submodule 2C1. The second submodule 2C2, or the third submodule 2C3, is configured to trigger an action of jamming the use detected at the communicating object at the origin of this use, respectively at a remote MANTEC server 3 from which the trusted equipment 2 requests assistance.

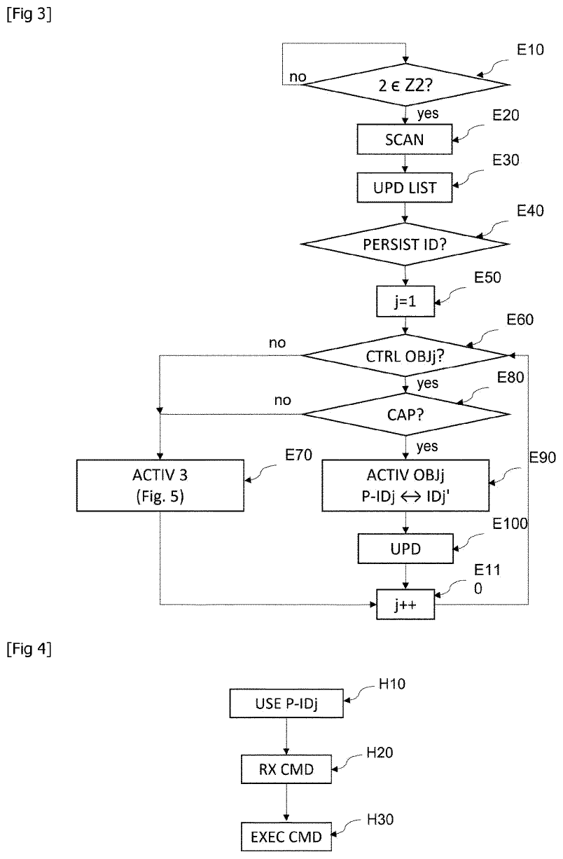

The functions of the modules 2A to 2C of the trusted equipment 2 are described in more detail below with reference to the steps of the monitoring method according to the invention that are illustrated in FIG. 3.

When the computer 4 is or hosts a MANTEC server 3 in accordance with the invention, the read-only memory 7 of the computer 4 comprises a recording of a computer program PROG3 comprising instructions defining the main steps of a management method according to the invention.

This program PROG3 defines functional modules of the MANTEC server 3 that rely on or control the hardware elements 5 to 9 of the computer 4 that are cited above. These modules comprise, in particular, in the embodiment described here:
a reception module 3A, configured to receive, from at least one trusted equipment associated with a user (in this case, in the example envisaged here, from the trusted equipment 2 associated with the user U), at least one instruction to trigger use of at least one given persistent identifier by at least one communicating object managed by the MANTEC server 3;
a selection module 3B, configured to select, for said at least one persistent identifier designated in said at least one instruction and for said user, at least one communicating object from among a plurality of communicating objects O1, . . . , Om managed by the MANTEC server 3, able to use said at least one persistent identifier. As mentioned above, to this end, the selection module 3B may consider the information contained in the profile of the user in question; and
a control module 3C, configured to send a command to said at least one selected communicating object so that it uses said at least one persistent identifier. This command may comprise an indication of a mode of use of said at least one persistent identifier (for example indicate whether the use should be real or fictitious (emulation) and/or indicate a behavior to be adopted by the communicating object in the event of an attempt and/or request, made by a third-party entity, to establish a connection with the communicating object on the basis of said at least one identifier). An attempt to establish a connection (also known as a partial request) consists here in initializing a connection request by sending a message to the communicating object, but without terminating this connection request.

The functions of the modules 3A to 3C of the MANTEC server 3 are described in more detail below with reference to the steps of the management method according to the invention that are illustrated in FIG. 4.

When the computer 4 is or hosts a communicating object Oj, j=1, . . . , m in accordance with the invention, the read-only memory 7 of the computer 4 comprises a recording of a computer program PROG comprising instructions defining the main steps of a use method according to the invention.

This program PROG defines functional modules of the communicating object Oj that rely on or control the hardware elements 5 to 9 of the computer 4 that are cited above. These modules comprise, in particular, in the embodiment described here:
a reception module 10A configured to receive, from a MANTEC server 3, a command to use a persistent identifier already being used by another communicating object, this command providing the communicating object Oj with an indication of at least one behavior to be adopted by said communicating object in the event of an attempt and/or request, made by a third-party device, to establish a connection by way of said persistent identifier. As mentioned above, this behavior more particularly defines the mode of use of the persistent identifier (for example actual use or fictitious use) recommended by the MANTEC server 3; and
an execution module 10B configured to use said persistent identifier and implement said at least one behavior.

Finally, when the computer 4 is or hosts a communicating object Oi′, an integer belonging to {1, . . . ,k} (for example i=1 in FIG. 1), in accordance with the invention, the read-only memory 7 of the computer 4 comprises a recording of a computer program PROG′ comprising instructions defining the main steps of an execution method according to the invention.

This program PROG′ defines functional modules of the communicating object Oi′ that rely on or control the hardware elements 5 to 9 of the computer 4 that are cited above. These modules comprise, in particular, in the embodiment described here:
a communication module 11A, configured to use a persistent identifier;
a reception module 11B, configured to receive a command from the trusted equipment 2 so that the communicating object Oi′ executes an action of jamming the use of the persistent identifier by the communication module 11A; and
an execution module 11C configured to execute this jamming action.

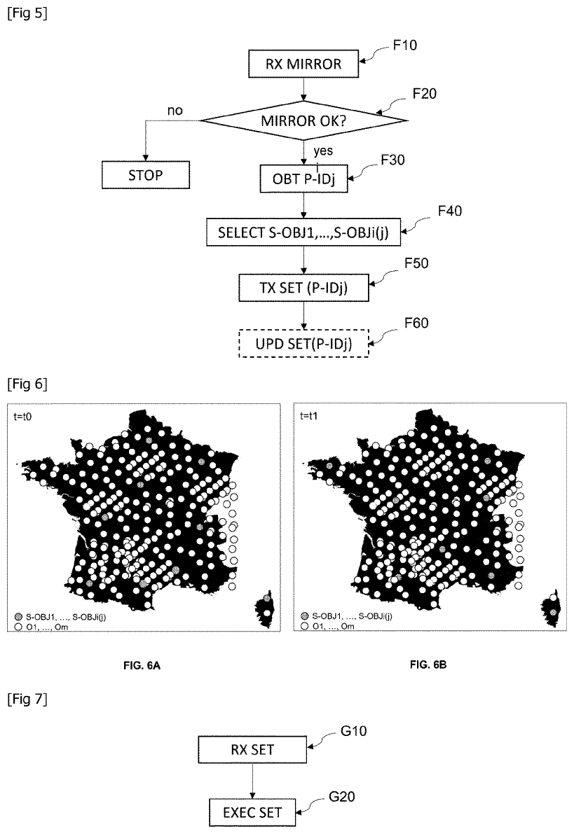

A description will now be given, with reference to FIGS. 3 to 7, of the main steps of the monitoring (FIG. 3), management (FIG. 5) and use (FIG. 7) methods implemented respectively by the trusted equipment 2 associated with the user U, by the MANTEC server 3, and by the communicating objects O1, . . . , Om in one particular embodiment. FIG. 4 illustrates the main steps of an execution method implemented, where applicable, by a communicating object from among the communicating objects O1′, . . . , Ok′ monitored by the trusted equipment 2.

With reference to FIG. 3, as mentioned above, in the embodiment described here, the first detection module 2A of the trusted equipment 2 associated with the user U monitors whether the trusted equipment 2 is located in its monitoring area Z2 (test step E10). To this end, for example, it uses the one or more parameters characterizing the monitoring area Z2 and compares same with the corresponding one or more parameters of the area in which it is located.

Thus, by way of illustration, if the parameter used to characterize the monitoring area Z2 is a network identifier valued at NwID, the first detection module 2A compares the identifier of the one or more networks to which the trusted equipment 2 is connected with the value NwID; if it detects a match, this means that the trusted equipment 2 is located in its monitoring area Z2, and otherwise that it is outside this area. As mentioned above, the monitoring area Z2 may, as a variant, be defined by an operation of excluding a specific value from the parameter in question, for example “NOT(NwID)”. In this case, the first detection module 2A detects that the trusted equipment 2 is located in its monitoring area Z2 if the trusted equipment 2 is not connected to any network having the identifier NwID.

As long as the trusted equipment 2 is not located in its monitoring area Z2 (response “no” in the test step E10), the modules 2B to 2C of the trusted equipment 2 remain inactive.

When the first detection module 2A detects that the trusted equipment 2 is located in its monitoring area Z2 (response “yes” in step E10), it activates the other modules of the trusted equipment 2, and more particularly the second detection module 2B.

Following this activation, the second detection module 2B scans the radio signals (for example Bluetooth signals, Wi-Fi signals) and/or the messages (for example ARP broadcast messages) transmitted by the communicating objects O1′, . . . , Ok′ located in its immediate radio and/or network neighborhood (step E20), with a view to detecting whether at least one of them is using a persistent identifier. For the sake of simplification here, it is assumed that the trusted equipment 2 monitors only the communicating objects located in its immediate neighborhood. However, as detailed above, as a variant, it is also possible to envisage that the trusted equipment 2 also monitors communicating objects located in a less immediate neighborhood, for example located at a greater distance from the trusted equipment 2 and connected, via a network or radio interface, to the communicating objects located in the immediate neighborhood of the trusted equipment 2.

In order to detect the use of one or more persistent identifiers, the second detection module 2B may be configured to recognize, among the data carried by the signals/messages detected in its neighborhood, particular identifiers (for example MAC address, IP address, etc.) or data sequences used on a recurring basis. This configuration may consist for example in specifying message headers and/or types of identifier to be searched for among these data. For each communicating object detected and monitored in its neighborhood, the second detection module 2B, in the embodiment described here, updates a list LIST comprising the identifiers carried by these communicating objects (step E30) and analyzes the duration for which these identifiers are used by said communicating objects to determine whether they are persistent identifiers liable to reveal identifying information about the user U. To this end, a maximum acceptable persistence duration Dmax is configured at the second detection module 2B. It should be noted that this maximum persistence duration may depend on the user U, the detected identifiers, the context in which the communicating objects O1′, . . . , Ok′ monitored by the trusted equipment 2 (for example secure or unsecure environment) are located, etc. Such a duration is for example 2 hours, 24 hours, 1 week, etc.

As a variant, the second detection module 2B may be configured with parameters acquired via executing a machine learning algorithm, the execution of which may be based for example on the production and operation of a neural network, making it possible to detect the existence of persistent identifiers in data, and providing the persistence duration and the type of each persistent identifier thus detected. The types of persistent identifier may be indicated explicitly in messages having these persistent identifiers or deduced by comparison with other known types of identifier (for example MAC address), or else result from configuration by the operator OP or by the user U, etc.

Based on the list LIST and on the one or more maximum acceptable persistence durations Dmax, the second detection module 2B is therefore able to identify the communicating objects using persistent identifiers (test step E40). In the remainder of the description, OBJ1, . . . , OBJn, n designating an integer greater than or equal to 1 and less than or equal to k, denotes the communicating objects among the communicating objects O1′, . . . , Ok′ using persistent identifiers detected, where applicable, by the second detection module 2B. It should be noted that the communicating objects OBJ1, . . . , OBJn may use one or more persistent identifiers. For the sake of simplification, it will be considered that each communicating object OBJ1, . . . , OBJn uses a single persistent identifier, respectively denoted P-ID1, . . . , P-IDn; however, assuming that multiple persistent identifiers are used by one and the same communicating object, what is described for one persistent identifier below is reproduced for all persistent identifiers used.

For each communicating object OBJj, j=1, . . . , n (steps E50 and E110), the trusted equipment 2 then determines, via its first submodule 2C1, which one or more types of jamming action to trigger in order to jam the use of the persistent identifier P-IDj by this communicating object OBJj. For this purpose, in the embodiment described here, the trusted equipment 2 takes into account the following two factors: the possibility of controlling the communicating object OBJj (so that the trusted equipment 2 is able to send commands thereto and so that these are accepted by the communicating object OBJj), and the ability of the object OBJj, where applicable, to execute a jamming action (commanded by the trusted equipment 2) itself, such as for example replacing the persistent identifier that it is using with another identifier.

The first submodule 2C1 therefore determines, first of all, whether it, or more specifically the user U, is able to control the communicating object OBJj using the persistent identifier P-IDj (test step E60). To this end, in the embodiment described here, the first submodule 2C1 determines whether the communicating object OBJj belongs to the user U or whether said user manages it. Multiple techniques may be used for this purpose by the first submodule 2C1.

For example, if the trusted equipment 2 is a CPE of the user U connected to a local area network of the user U and the persistent identifier P-IDj is a MAC address, the first submodule 2C1 may consult the table of active connections in the local area network maintained by the trusted equipment 2 (for example ARP (Address Resolution Protocol) table or DHCP (Dynamic Host Configuration Protocol) database) and verify whether the object OBJj is connected to the local area network with its MAC address P-IDj.

According to another technique, in order to determine whether the communicating object OBJj is able to be controlled by the user U, the first submodule 2C1 may exchange messages with the communicating object OBJj, for example ICMP (Internet Control Message Protocol) messages, or by establishing an association with the communicating object OBJj using a radio interface used thereby (for example Bluetooth).

According to yet another technique, the first submodule 2C1 may ask the user U to indicate whether they are able to control this object OBJj (for example to indicate whether the object OBJj belongs to them or whether said user manages it), for example by displaying a message on a terminal (for example smartphone, display screen of a CPE, connected TV) of the user U.

According to yet another technique, the first submodule 2C1 may rely on statements made by the user U when subscribing to the service S.

Of course, other techniques may be envisaged in addition to or as a replacement for the above techniques. As mentioned above, the fact that the communicating object OBJj is under the control of the user U allows it to be controlled here by the trusted equipment 2 (designated as such by the user U) and thus allows the trusted equipment 2 to address commands to execute jamming actions to the communicating object OBJj, the latter being configured to accept these commands and execute them if it is able to do so.

In the embodiment described here, if the communicating object OBJj is not under the control of the user U (response “no” in the test step E60), then the first submodule 2C1, via the third submodule 2C3, triggers an action of jamming the use of the persistent identifier P-IDj by the communicating object OBJj at a MANTEC server 3 (step E70), as described in more detail below.

If the communicating object OBJj is under the control of the user U (response “yes” in the test step E60), for example because it belongs to the user U, the first submodule 2C1 verifies, second of all, whether the communicating object OBJj is capable of executing an action of jamming its use of the persistent identifier P-IDj (test step E80). More particularly, in the embodiment described here, the first submodule 2C1 determines whether the communicating object OBJj is able to execute an action of randomizing the persistent identifier P-IDj that it is using. Such a technique comprises for example the choice or generation on demand, by the communicating object OBJj, of a new identifier of the same nature as the identifier P-IDj (in the example: of a MAC address or an IP address, the generation of a new MAC address or a new IP address, respectively), for example randomly, and the use, by the communicating object OBJj, of the new identifier thus generated in place of the identifier P-IDj. As a variant, the new identifier of the same nature as the persistent identifier P-IDj may be chosen or generated by another entity such as the trusted equipment 2 or a third-party entity, and may be provided to the communicating object OBJj by the trusted equipment 2 or directly by this other entity.

The first submodule 2C1 is able to determine the capability of the communicating object OBJj to execute such a jamming action in various ways.

For example, it may interrogate the communicating object OBJj or consult a database in which such a capability is indexed.

As a variant, it may be envisaged to define a specific DHCP or DHCPv6 or ICMPv6 option, sent by the communicating object OBJj (for example when it connects to the local area network of the trusted equipment 2 when this is a CPE or in response to an ICMP message sent by the trusted equipment 2 to the communicating object OBJj). By way of illustration and without any limitation, we will call this specific option “MAC_UPDATE” when the identifier in question is a MAC address. This option may contain an identifier of an API (Application Programming Interface) supported by the communicating object OBJj to request the renewal of a MAC address; such an API is for example the DHCP RECONFIGURE reconfiguration procedure described in document RFC 8415 published by the IETF entitled “Dynamic Host Configuration Protocol for IPV6 (DHCPv6)”, November 2018 (paragraph 16.11). As a variant, other procedures may be used.

If the communicating object OBJj is not able to execute a jamming action (response “no” in the test step E80) and more particularly, here, an action of randomizing the persistent identifier P-IDj that it is using, the first submodule 2C1 then, via the third submodule 2C3, triggers an action of jamming the use of the persistent identifier P-IDj by the communicating object OBJj at a MANTEC server 3 (step E70), as described in more detail below with reference to FIG. 5.

If, on the other hand, the communicating object OBJj is able to execute a jamming action (response “yes” in the test step E80), and more particularly, here, an action of randomizing the persistent identifier P-IDj that it is using, it is a communicating object in accordance with the invention, using a persistent identifier P-IDj (cf. step H10 in FIG. 4), and having modules configured to implement an execution method according to the invention (cf. modules 11A-11C shown in broken lines in FIG. 1 for the object O1′). The first submodule 2C1 then triggers the execution of such a jamming action at the communicating object OBJj via the second submodule 2C2 of the trusted equipment 2, so as to force the communicating object OBJj to use another identifier of the same nature as the identifier P-IDj (step E90).

The second submodule 2C2 of the trusted equipment 2 sends a command CMD to the communicating object OBJj in this sense.

By way of illustration, such a command CMD comprises the instruction to trigger a DHCP RECONFIGURE reconfiguration procedure and comprises the specific option mentioned above (MAC_UPDATE option for a MAC address identifier) including an indication of a renewal interval of the persistent identifier, preferably less than or equal to the maximum acceptable persistence duration for the identifier in question. According to another example, no indication of a renewal interval is provided, but the second submodule 2C2 of the trusted equipment 2 is configured to trigger the renewal of the persistent identifier regularly (with a period preferably less than or equal to the maximum acceptable persistence duration for the identifier in question) or at given times (for example when the communicating object OBJj is invoked to respond to a command generated by a controller).

With reference to FIG. 4, following the receipt of the command CMD from the trusted equipment 2 (step H20), the communicating object OBJj executes the jamming action asked thereof, namely here an action of randomizing the persistent identifier P-IDj (step H30). More specifically, it obtains a new identifier IDj′ of the same nature as the identifier P-IDj (it may for example generate it or use a new identifier IDj′ provided by the trusted equipment 2 or by a third-party entity as mentioned above) and uses it as a replacement for the identifier P-IDj in accordance with the instructions indicated by the command CMD. For example, it uses this identifier IDj′ for all of its ongoing connections that were using the persistent identifier P-IDj.

Following the renewal of the persistent identifier P-IDj by the communicating object OBJj with the new identifier IDj′ of the same nature, the trusted equipment 2 may, if necessary, update the routing and/or traffic filtering rules relating to the communicating object OBJj so as to take account of the new identifier IDj′ used thereby (step E100). When the trusted equipment 2 is a CPE, this updating may be carried out directly by the trusted equipment 2. As a variant, it may be triggered by the trusted equipment 2 at another appropriate entity. The purpose of this updating is to avoid the service provided by the communicating object OBJj being impacted by the modification of the identifier (in particular from the point of view of accessing the service), and in particular to avoid degradation of this service.

A more detailed description will now be given of the triggering, by the trusted equipment 2, of an action at a MANTEC server 3 of jamming the use of the persistent identifier P-IDj by the communicating object OBJj, as envisaged in particular in step E70. It should be noted that, in the embodiment described here, the assistance of a MANTEC server 3 is invoked by the trusted equipment 2 when the communicating object OBJj is not under the control of the user U or when the communicating object OBJj is not able itself to execute a given jamming action, such as for example here a technique of generating random identifiers. However, these assumptions are not limiting, and it is possible to envisage invoking a MANTEC server 3 in other cases. In particular, the MANTEC server 3 may be invoked including when the communicating object OBJj is under the control of the user and when it is able itself to execute a given jamming action in order to reinforce the jamming of the use of the persistent identifier P-IDj by the communicating object OBJj (and increase the level of noise associated with this jamming).

The intervention of a MANTEC server 3 is described with reference to FIG. 5 and to the main steps of a management method according to the invention that is then implemented by said MANTEC server 3. This involves triggering an action of jamming the use of the persistent identifier P-IDj by the communicating object OBJj within the meaning of the invention.

More particularly, the intervention of a MANTEC server 3 is triggered in step E70 by the third submodule 2C3 of the trusted equipment 2, which, after having established an association/connection with the one or more MANTEC servers 3 with which it has been configured for the user U, sends, to the one or more MANTEC servers 3, a command message comprising an instruction to trigger use of the persistent identifier P-IDj, being used by the communicating object OBJj, by at least one other communicating object selected by the one or more MANTEC servers 3. As indicated above, in the example envisaged here for the sake of simplification, the third submodule 2C3 of the trusted equipment 2 sends the command message to a single MANTEC server 3.

In the embodiment described here, the command message addressed to the MANTEC server 3 relies on a specific method dedicated to the invention, that is to say defined for this purpose, called MIRROR for example. The MIRROR command message comprises a list of persistent identifiers to be used (for example a list of identifiers to be emulated, that is to say to be used “artificially” in order to add noise to their original use, by the communicating objects selected by the MANTEC server 3. It should be noted that the list of persistent identifiers contained in the MIRROR command message may group together the persistent identifiers used by multiple communicating objects OBJ1, . . . , OBJn, or the one or more persistent identifiers used by a single communicating object OBJj. In other words, the MIRROR command message may group together instructions relating to multiple communicating objects OBJj, j=1, . . . , n and therefore multiple persistent identifiers P-IDj used respectively by these communicating objects, or instructions relating to just one of them. In the latter case, a MIRROR command message is sent for each eligible object OBJj (that is to say for which it has been decided to trigger assistance from the MANTEC server 3).

The MIRROR command message may also comprise other optional information, such as for example an indication of the user U concerned by the message, an indication of a duration of use of the persistent identifiers designated by the command message and/or an area to which the one or more communicating objects selected by the MANTEC server 3 that will use these one or more persistent identifiers should be attached, a mode of use of the persistent identifiers by the communicating objects selected by the MANTEC server 3 (for example actual or fictitious use or a mix of both). As a variant, this information may be obtained by the MANTEC server 3 in other ways, for example by consulting the profile of the user U. According to another variant, the MANTEC server 3 may use default values (for example 24 hours for the duration of use) if this information is not mentioned in the MIRROR command message or in the profile of the user U.

If the trusted equipment 2 wishes to renew the intervention of the MANTEC server 3 beyond the indications provided in the MIRROR command message, in this case, it may send a new MIRROR command message to the MANTEC server 3. Conversely, if the trusted equipment 2 wishes to interrupt the intervention of the MANTEC server 3, it may send thereto a message to this effect, for example based on a DELETE method as defined by the RESTCONF protocol, adapted so that it indicates the list of persistent identifiers affected by the interruption.

There is no limitation attached to the protocol used to support communications between the trusted equipment 2 and the MANTEC server 3. It may be for example the TCP (Transmission Control Protocol), QUIC, RESTCONF, HTTP (Hypertext Transfer Protocol), CoAP (Constrained Application Protocol), etc. protocol. For the HTTP, RESTCONF or CoAP protocols, the MIRROR method may be implemented using either of the PUT or POST mechanisms supported by these protocols.

With reference to FIG. 5, the MIRROR command message is received by the MANTEC server 3 (step F10). In the remainder of the description, for the sake of simplification, it is assumed that the MIRROR command message received by the MANTEC server 3 comprises a single persistent identifier P-IDj used by the communicating object OBJj. Those skilled in the art would have no difficulty in adapting the following steps when the command message comprises multiple persistent identifiers used by one and the same communicating object or by multiple distinct communicating objects.

In the embodiment described here, upon receipt of the MIRROR command message by its reception module 3A from the trusted equipment 2, the MANTEC server 3, via its reception module 3A, determines the user U concerned by the MIRROR command message and with which the trusted equipment 2 is associated. This information may be obtained by the reception module 3A by virtue of the prior association of the trusted equipment 2 with the MANTEC server 3, carried out upon the establishment of their connection and on the basis of which the trusted equipment 2 sent its command message. The reception module 3A then verifies that the trusted equipment 2 is authorized to address thereto such a message for the user U (test step F20). Such a verification may consist for example in authenticating the connection establishment request from the trusted equipment 2. Other checks may be carried out during this verification, such as for example ensuring that the trusted equipment 2 is indeed authorized to address command messages relating to the user U, or that the trusted equipment 2 is still able to address jamming requests for the user U with regard to the maximum number of identifiers to be jammed associated with the user U, etc., the information allowing these verifications to be carried out being able to be obtained by the MANTEC server 3 based on the profile of the user U or based on information declared by the user U when subscribing to the service S. If the trusted equipment 2 is used by multiple users and only one connection is used with the MANTEC server 3 for the needs of the service S, it is possible to envisage that the MIRROR command message identifies the user U and that the MANTEC server 3 consults the profile of the user U indicated by the trusted equipment 2 in the MIRROR message in order to determine whether the latter is associated explicitly with said user.

If the trusted equipment 2 is not authorized (response “no” in the test step F20), the MIRROR command message is rejected by the MANTEC server 3 via its reception module 3A (step F30). In other words, no jamming action is implemented by the MANTEC server 3.

Otherwise (response “yes” in the test step F20), the reception module 3A of the MANTEC server 3 validates the MIRROR command message and extracts the various information contained in the message (list of persistent identifiers to be used, and possibly duration of use, area in which to trigger use, etc.) (step F40).

Thus, by way of illustration, in the example envisaged here, the reception module 3A extracts the persistent identifier P-IDj from the MIRROR message and determines that the user U is concerned by this message (directly based on the MIRROR message or on the association with the trusted equipment 2 as mentioned above), thereby allowing it to access the abovementioned elements contained in the profile of the user U concerning the jamming to be adopted (for example area of intervention Z3 of the MANTEC server 3, desired level of jamming, types of persistent identifier, etc.).

Based on these elements, the selection module 3B of the MANTEC server 3 selects one or more communicating objects from among the communicating objects O1, . . . , Om that it manages in order to use (in addition to the communicating object OBJj) the persistent identifier P-IDj extracted from the MIRROR message (step F50). S-OBJ1, . . . , S-OBJi(j), i(j) designating an integer greater than or equal to 1 and less than or equal to m, is used to designate the one or more communicating objects thus selected by the selection module 3B to use the identifier P-IDj. The number i(j) depends on the desired level of jamming, that is to say on the level of noise that it is desired to introduce when jamming the use of the identifier P-IDj so as to cancel out the effect of the communicating object OBJj persistently using this identifier P-IDj. This level of noise may reflect a preference expressed by the user, or may be imposed by the operator OP of the service S, for example depending on the conditions under which the user U subscribes to the service S, or determined depending on context, etc. It is defined here in the profile of the user U.

The selection module 3B also determines, in the embodiment described here, for each of the selected objects S-OBJ1, . . . , S-OBJi(j), the mode of use of the persistent identifier P-IDj by these objects. This mode of use may differ from one object to another (and from one identifier to another if multiple persistent identifiers are used by one and the same object); for example, some objects may be selected to emulate the persistent identifier P-IDj, and others to actually use it. This mode of use, in the example envisaged here, is characterized by the one or more behaviors to be adopted by the object in question in the event of an attempt and/or a request, made by another entity, to establish a connection with the object on the basis of the persistent identifier P-IDj, for example rejecting the establishment attempt and/or request, storing the establishment attempt and/or request (that is to say in order to trace them), accepting the establishment attempt and/or request, etc. However, this assumption is not limiting per se and it is possible to envisage characterizing the mode of use chosen for a communicating object S-OBJ1, . . . , S-OBJi(j) differently (for example by associating, with the mode of use, a particular designation (for example “EMUL”) that echoes the one or more behaviors to be adopted by the communicating object (for example “reject any connection attempt and/or request”).

It should be noted that the mode of use of the persistent identifier P-IDj may be chosen by the MANTEC server 3 alone and/or taking into account an instruction provided by the trusted equipment 2 (for example in the MIRROR message as mentioned above), or else be defined by default.

In the illustrative example envisaged here, it is assumed, for the sake of simplification, that the selection module 3B requests emulation of the persistent identifier P-IDj by each of the objects S-OBJp, p=1, . . . ,i(j).

As mentioned above, such emulation of the persistent identifier P-IDj consists, for an object S-OBJp, p=1, . . . ,i(j), in artificially using the identifier P-IDj so that use thereof by the communicating object OBJj is no longer able to reveal information characteristic of the user U, that is to say liable to identify them or reveal elements about their behavior or even their habits. In other words, by virtue of this emulation, communicating objects other than the communicating object OBJj that may be “attached” to the user U (although not necessarily belonging thereto, as mentioned above) will be associated with the use of the identifier P-IDj. Since these communicating objects are located in a duly chosen context (for example in a geographical area that is “insignificant” for the user U, typically an area in which they are unlikely to be located), the simultaneous use of the identifier P-IDj by the objects S-OBJ1, . . . , S-OBJi(j) and by the communicating object OBJj will annihilate any possibility of deducing information critical for the user U from this use.

More particularly, the emulation of the persistent identifier P-IDj by a communicating object S-OBJp consists here in assigning the identifier P-IDj to one of the interfaces of the communicating object S-OBJp such that it is visible to the equipments scanning the area to which it is attached or that carry out said association. The communicating object S-OBJp is also configured not to use this identifier P-IDj for its own needs (for example when it sends an activity report upon request of an external controller), and to reject any attempt and/or request to establish a connection that it receives from third parties on the basis of this identifier.

The communicating objects S-OBJ1, . . . , S-OBJi(j) may be selected from among the communicating objects O1, . . . , Om managed by the MANTEC server 3 according to various criteria: randomly, depending on at least one constraint defined for or by the user U (for example area of intervention Z3, mobility situation, etc.), etc.

In the example envisaged here, the communicating objects S-OBJ1, . . . , S-OBJi(j) are selected from the area of intervention Z3 defined, where applicable, in the profile of the user U. For example, the user U is a person carrying out a commercial mission in a company; the area Z2 monitored by the trusted equipment 2 corresponds to the local area network of the company, while the area Z3 is defined for this user U according to the travel plans of the user U in line with their commercial mission (this is for example an area that the user U has to visit as part of this mission). The communicating objects S-OBJ1, . . . , S-OBJi(j) are chosen so as to be distributed uniformly in the area Z3. As a variant, it is possible to envisage an area Z3 remote from the places concerned by the travel plans of the user U.

As a variant, the identification of this area of intervention Z3 may be carried in the MIRROR message received from the trusted equipment 2, or may be defined by default.

The selected communicating objects S-OBJ1, . . . , S-OBJi(j) may be connected to the same network as the MANTEC server 3 or belong to a dedicated network, and are attached to the area of intervention Z3. The area of intervention Z3 may be a district, a city, a CPE network, a hotspot network, etc. Like for the area Z2, the attachment to the area of intervention Z3 is therefore not necessarily linked to a geographical location; an area of intervention Z3 may be characterized for example by a network identifier, an IP prefix or address, GPS coordinates delimiting a geographical area, or a combination of such parameters. The communicating objects attached to this area of intervention Z3 are managed by the MANTEC server 3 and under its control.

Thus, at the end of the selection step F50, the MANTEC server 3 has a “map” of communicating objects to be contacted to execute actions of jamming the use of the persistent identifier P-IDj by the communicating object OBJj, and more particularly here to emulate the identifier P-IDj. It should be noted that the map in question may change over time (regularly or at determined times) as illustrated by FIGS. 6A and 6B, for example so as to emulate a mobility situation (in other words, the communicating objects selected by the selection module 3B, and possibly the number thereof, may differ over time). FIGS. 5A and 5B illustrate one example of the change of a map of communicating objects between two times t=t0 and t=t1, the white circles representing the communicating objects O1, . . . , Om managed by a MANTEC server 3 and the gray circles representing the communicating objects S-OBJ1, . . . , S-OBJi(j) selected by the MANTEC server 3 to emulate the persistent identifier P-IDj.

The MANTEC server 3 then sends, via its control module 3C, to the communicating objects S-OBJ1, . . . , S-OBJi(j) thus selected, a command to use the persistent identifier P-IDj (step F60). This command may be executed by the communicating object in question as soon as it is received or starting from a time indicated in the command (in particular in the event of a change in the communicating objects selected to emulate the identifier P-IDj over time). Such a command may be for example a message in accordance with the NETCONF or RESTCONF protocols, for example called SET in the example envisaged here, comprising the identifier P-IDj to be used and possibly other information such as for example the duration of use of this identifier P-IDj by the communicating object to which the command is addressed, or the one or more behaviors to be adopted in the event of connection requests associated with this identifier (for example accept the association request, just broadcast the identifier, but without accepting an association request, or keep track of connection establishment requests), or more generally the mode of use of the identifier P-IDJj by the communicating object, etc. It should be noted that, depending on the implementation details chosen to implement the invention, the message SET may implicitly comprise the mode of use of the persistent identifier P-IDJj chosen by the selection module 3B (for example, emulation of the persistent identifier P-IDJj) or comprise a parameter explicitly indicating this mode of use (for example, a certain value of the parameter indicating a behavior to be adopted in the event of an attempt and/or request to establish a connection based on the persistent identifier or indicating more generally a mode of use of the persistent identifier with the one or more associated behaviors, for example “EMUL”, this mode of use being associated with the behavior “reject any attempt and/or request to establish a connection based on the identifier P-IDj”).

With reference to FIG. 7, following receipt (G10) of the command SET from the MANTEC server 3 via their respective reception modules 10A, the communicating objects S-OBJ1, . . . , S-OBJi(j) use their execution modules 10B to execute the instructions contained implicitly and/or explicitly in the command and use the identifier P-IDj in accordance with these instructions (G20). This advantageously results in jamming of the use of the identifier P-IDj by the object OBJj.

It should be noted that, if the MANTEC server 3 has already been invoked by another trusted equipment 2 for the user U and for the persistent identifier P-IDj, the MANTEC server 3 may decide to use the communicating objects selected when the other trusted equipment is invoked and extend the duration of use of the identifier P-IDj by these communicating objects.

At any time, the MANTEC server 3 may contact the communicating objects S-OBJ1, . . . , S-OBJi(j) selected to use the identifier P-IDj in order to cancel or renew the use of the identifier P-IDj by these communicating objects (optional step F70). This may be carried out by way of an appropriate command, for example in accordance with the NETCONF or RESTCONF protocols.

It should be noted that the invention has just been described in one particular embodiment in which the jamming system 1 comprises at least one trusted equipment associated with the user, at least one MANTEC server and a plurality of communicating objects managed by this MANTEC server and configured to implement a use method according to the invention. Other configurations may of course be envisaged. The jamming system 1 may in particular include one or more communicating objects among the communicating objects monitored by the trusted equipment, configured to implement an execution method according to the invention. In general, the jamming system 1 relies on a plurality of communicating objects in accordance with the invention that may be configured to implement the execution method according to the invention and/or the use method according to the invention.

1. A monitoring method for monitoring communicating objects, carried out by a trusted equipment associated with a user, said monitoring method comprising:
detecting use of at least one persistent identifier by at least one communicating object; and
triggering at least one action of jamming said use of said at least one persistent identifier by said at least one communicating object.

2. The monitoring method as claimed in claim 1, furthermore comprising, for at least one said communicating object identified by the detecting and at least one persistent identifier used by this identified communicating object, determining whether said identified communicating object is able to execute said action of jamming the use of the persistent identifier, the triggering step comprising, where applicable, sending a command to this identified communicating object so that this identified communicating object executes said action of jamming.

3. The monitoring method as claimed in claim 2, wherein said action of jamming comprises said identified communicating object using another identifier of a same nature as said persistent identifier in place thereof.

4. The monitoring method as claimed in claim 3, wherein said other identifier is chosen by said identified communicating object or by said trusted equipment.

5. The monitoring method as claimed in claim 3, furthermore comprising updating at least one routing and/or traffic filtering rule relating to said identified communicating object with said other identifier.

6. The monitoring method as claimed in claim 1, wherein, for at least one said communicating object identified by the detecting and at least one persistent identifier used by this identified communicating object, said triggering comprises sending, to at least one remote server, an instruction to trigger use of this persistent identifier by at least one other communicating object selected by said at least one remote server.

7. The monitoring method as claimed in claim 6, wherein said instruction furthermore comprises an indication of a duration of use of said persistent identifier by said at least one other communicating object and/or an area to which said at least one other communicating object should be attached.

8. A management method for managing communicating objects, carried out by a server, said management method comprising:
receiving, from a trusted equipment associated with a user, an instruction to trigger an action of jamming use of at least one persistent identifier by a communicating object, said action of jamming comprising at least one other communicating object managed by said server using said at least one persistent identifier;
selecting, for said at least one persistent identifier designated in said instruction and for said user, at least one communicating object from among a plurality of communicating objects managed by the server, able to use said at least one persistent identifier; and
sending a command to said at least one selected communicating object to use said at least one persistent identifier.

9. The management method as claimed in claim 8, furthermore comprising, before executing the selecting and the sending, authenticating the trusted equipment associated with the user.

10. The management method as claimed in claim 8, wherein said at least one selected communicating object is selected by said server from among a plurality of the communicating objects that are managed by the server and attached to an area defined for said user.

11. The management method as claimed in claim 8, wherein at least one said selected communicating object is selected randomly by said server or according to at least one constraint defined for said user.

12. The management method as claimed in claim 8, furthermore comprising, for at least one said communicating object selected for said user, cancelling or renewing said command to use said at least one persistent identifier for which said communicating object has been selected.

13. The monitoring method as claimed in claim 1, wherein at least one said persistent identifier is:
a MAC, Medium Access Control Layer, address;
an IP, Internet Protocol, address;
an IP prefix;
a Service Set Identifier, SSID;
an identifier of the trusted equipment; or
an identifier assigned to a radio interface.

14. (canceled)

15. (canceled)

16. A trusted equipment associated with a user, configured to monitor communicating objects, said trusted equipment comprising:
at least one processor; and
at least one non-transitory computer readable medium comprising instructions stored thereon which when executed by the at least one processor configure the trusted equipment to:
detect use of at least one persistent identifier by at least one communicating object; and
trigger at least one action of jamming said use of said at least one persistent identifier by said at least one connected object.

17. A server configured to manage communicating objects, said server comprising:
at least one processor; and
at least one non-transitory computer readable medium comprising instructions stored thereon which when executed by the at least one processor configure the server to:
receive, from at least one trusted equipment associated with a user, at least one instruction to trigger an action of jamming use of at least one persistent identifier by a communicating object, said action of jamming comprising in at least one other communicating object managed by said server using said at least one persistent identifier;
select, for said at least one persistent identifier designated in said at least one instruction and for said user, at least one communicating object from among a plurality of communicating objects managed by the server, able to use said at least one persistent identifier; and
send a command to said at least one selected communicating object to use said at least one persistent identifier.

18. A communicating object comprising:
at least one processor; and
at least one non-transitory computer readable medium comprising instructions stored thereon which when executed by the at least one processor configure the communicating object to:
use a persistent identifier;
receive a command from a trusted equipment associated with a user so that the communicating object executes an action of jamming the use of said persistent identifier by said communication module; and
execute said jamming action of jamming.

19. A communicating object comprising:
at least one processor; and
at least one non-transitory computer readable medium comprising instructions stored thereon which when executed by the at least one processor configure the communicating object to:
receive, from a server, a command to execute an action of jamming use of a persistent identifier by another communicating object, said action of jamming comprising in using said persistent identifier already being used by said other communicating object, said command providing said communicating object with an indication of at least one behavior to be adopted by said communicating object in the event of an attempt and/or request, made by a third-party device, to establish a connection with the communicating object by way of said persistent identifier; and
use said persistent identifier and implement said at least one behavior.

20. (canceled)
